(19) United States
(12) Patent Application Publication
(10) Pub. No.: US 2019/0095088 A1
(43) Pub. Date: Mar. 28, 2019

(54) ELECTRONIC APPARATUS AND METHOD FOR CONTROLLING ELECTRONIC APPARATUS

(71) Applicant: SEIKO EPSON CORPORATION, Tokyo (JP)

(72) Inventor: Hiroyuki HASHIMOTO, Suwa-gun (JP)

(73) Assignee: SEIKO EPSON CORPORATION, Tokyo (JP)

(21) Appl. No.: 16/139,190

(22) Filed: Sep. 24, 2018

(30) Foreign Application Priority Data
Sep. 25, 2017 (JP) 2017-183296
Sep. 25, 2017 (JP) 2017-183297

(51) Int. Cl. G06F 3/0484; G06F 3/033; G03B 21/14

(52) U.S. Cl. CPC G06F 3/04847; G03B 21/14; G06F 3/033

(57) ABSTRACT

An electronic apparatus includes an execution section that executes communication of image information with an external apparatus, an attachment section to which a device is attachable, and a control section that controls communication between the device attached to the attachment section and the external apparatus during a period for which the execution section executes the communication of the image information with the external apparatus.

### BACKGROUND

### 1. Technical Field

The present invention relates to an electronic apparatus and a method for controlling the electronic apparatus.

### 2. Related Art

JP-A-2015-176536 describes a system including a projector and a terminal apparatus, such as a personal computer. In the system, the projector and the terminal apparatus are first wirelessly connected to each other, and image information is then transmitted from the terminal apparatus to the projector.

Widespread use of the USB (universal serial bus) and other standards allows a variety of devices to be attached to an electronic apparatus, such as the projector described in JP-A-2015-176536. In such a situation, the convenience of a terminal apparatus, such as a personal computer, and an electronic apparatus, such as a projector, is improved if the electronic apparatus and the terminal apparatus can communicate with each other.

### SUMMARY

An advantage of some aspects of the invention is to allow an external apparatus, such as a terminal apparatus, to communicate with a device attached to an electronic apparatus.

An electronic apparatus according to an aspect of the invention includes an execution section that executes communication of image information with an external apparatus, an attachment section to which a device is attachable, and a control section that controls communication between the device attached to the attachment section and the external apparatus during a period for which the execution section executes the communication of the image information with the external apparatus.

An electronic apparatus according to another aspect of the invention includes an attachment section to which a device is attachable and a setting section that sets a state of the device attached to the attachment section in accordance with operation input to be any of a first state in which the device is connected to the external apparatus connected to the electronic apparatus, a second state in which the device is connected to the electronic apparatus, and a third state in which the device is not connected to the external apparatus or the electronic apparatus.

A method for controlling an electronic apparatus according to another aspect of the invention is a method for controlling an electronic apparatus including an attachment section to which a device is attached, the method including executing communication of image information with an external apparatus and controlling communication between the device attached to the attachment section and the external apparatus during a period for which the communication of the image information with the external apparatus is executed.

A method for controlling an electronic apparatus according to another aspect of the invention is a method for controlling an electronic apparatus including an attachment section to which a device is attached, the method including setting a state of the device attached to the attachment section in accordance with operation input to be any of a first state in which the device is connected to an external apparatus connected to the electronic apparatus, a second state in which the device is connected to the electronic apparatus, and a third state in which the device is not connected to the external apparatus or the electronic apparatus.

### BRIEF DESCRIPTION OF THE DRAWINGS

The invention will be described with reference to the accompanying drawings, wherein like numbers reference like elements.

FIG. 1 shows a projector according to a first embodiment.

FIG. 2 shows an example of the projector and a PC.

FIG. 3 shows an example of a projection section.

FIG. 4 shows an operation screen.

FIG. 5 shows an example of a web-screen.

FIG. 6 is a sequence diagram for describing an example of the actions of the projector and the PC.

### DESCRIPTION OF EXEMPLARY EMBODIMENTS

Embodiments according to the invention will be described below with reference to the drawings. In the drawings, the dimension and scale of each portion differ from actual values as appropriate. Further, the embodiments described below are preferable specific examples of the invention. A variety of technically preferable restrictions are therefore imposed on the embodiments. The scope of the invention is, however, not limited to the restricted forms unless otherwise particularly stated in the following description that a restriction is imposed on the invention.

### First Embodiment

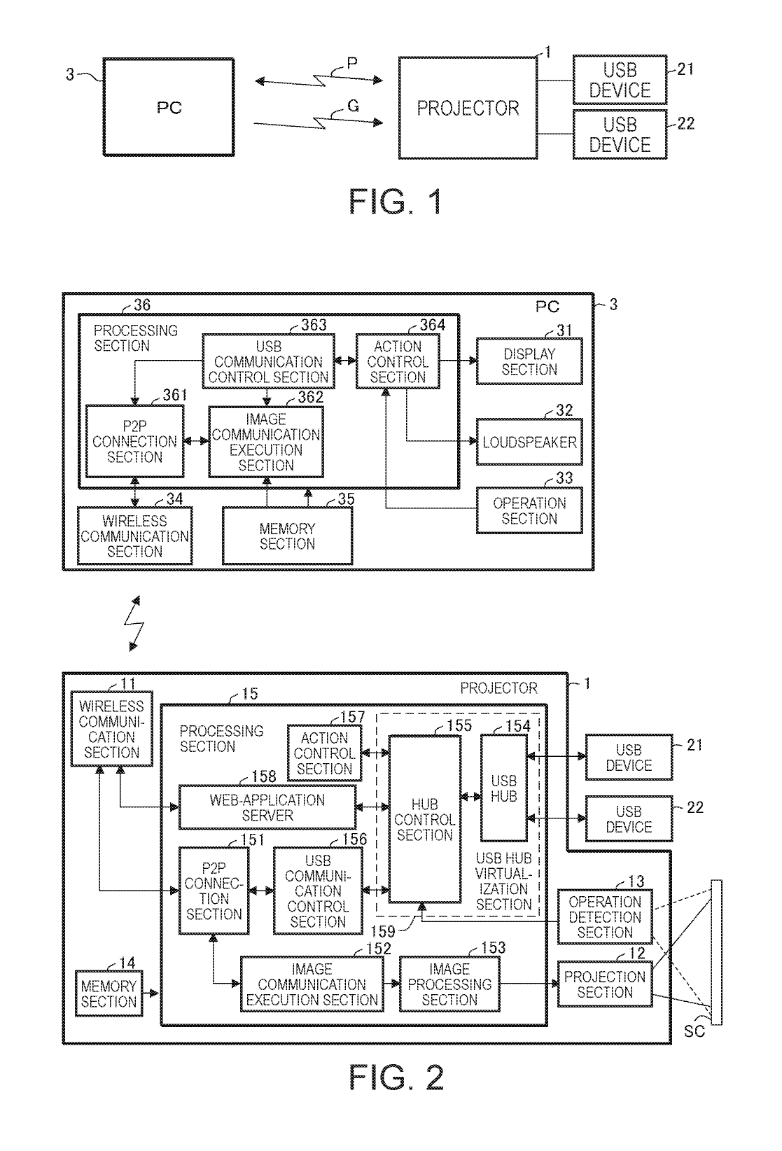

FIG. 1 shows a projector 1 according to a first embodiment.

The projector 1 is an example of an electronic apparatus and a display apparatus. USB devices 21 and 22 are attached to the projector 1.

The USB device 21 is a USB device that does not belong to a human-interface-devices (HID) class. In the present embodiment, the USB device 21 is a camera device. The HID class is an example of a specific kind. The USB device 21 is an example of a first device other than a device of the specific kind.

The USB device 22 is a device that belongs to the HID class. In the present embodiment, the USB device 22 is a pen or any other pointing device that is used to write a line or any other figure on an image projected by the projector 1 by using an interactive drawing function of the projector 1. The USB device 22 is an example of a second device of the specific kind.

The projector 1 belongs to a network to which a personal computer (PC) 3 belongs. The projector 1 can be wirelessly connected to the PC 3.

The USB devices 21 and 22 attached to the projector 1 can instead be directly attached to the PC 3. However, for example, in a case where the projector 1 is spatially separate from the PC 3 and a user faces the projector 1, it is undesirable to directly attach the USB devices 21 and 22 to the PC 3 from the viewpoint of prevention of theft of the USB devices 21 and 22 and other factors.

Therefore, in the present embodiment, the projector 1 controls communication between the USB devices 21, 22 and the PC 3 in such a way that the USB devices 21 and 22 attached to the projector 1 are under the management of the PC 3.

The projector 1 is wirelessly connected to a PC 3 and executes image information communication with the PC 3 in accordance with the Miracast standard. In the Miracast standard, P2P (peer to peer) connection is used for inter-apparatus connection. In the Miracast standard, real-time streaming protocol (RTSP) is used for control of image information transmission, and real-time transport protocol (RTP) is used for actual image information transmission.

In the present embodiment, “attachment” refers to physical attachment irrespective of whether or not information communication is executed. On the other hand, “connection” means transmission of information, reception of information, or transmission and reception of information.

In the case where the projector is connected to the PC 3 in the P2P connection, the projector 1 does not connect the USB device 21 to the PC 3 but connects the USB device 22 to the PC 3 to suppress an increase in processing burden on the PC 3 as a result of the connection between the PC 3 and the projector 1.

For example, the projector 1 does not transmit first attachment information representing that the USB device 21 has been attached to a USB hub 154, which will be described later in FIG. 2, to the PC 3 but transmits second attachment information representing that the USB device 22 has been attached to the USB hub 154 to the PC 3.

In this case, the PC 3 does not perform plug-and-play operation relating to the USB device 21 but performs plug-and-play operation relating to the USB device 22. The plug-and-play operation is performed when two apparatuses are connected to each other and allows one of the apparatuses can use the function of the other apparatus. For example, the one apparatus allocates resources for the other apparatus and installs device drivers for the other apparatus in order to be capable of using the function of the other apparatus.

Since the PC 3 does not perform plug-and-play operation relating to the USB device 21, the processing burden on the PC 3 can be suppressed, as compared with a case where the plug-and-play operation relating to the USB device 21 is performed.

When the PC 3 performs plug-and-play operation relating to the USB device 22, the PC 3 is connected to the USB device 22 in accordance with the USB standard. The connection in accordance with the USB standard is hereinafter referred to as “USB connection.”

The USB device 21, which is not connected to the PC 3 in the form of USB connection when the projector 1 is connected to the PC 3, is also connected to the PC 3 as required.

The projector 1, when it receives a first connection instruction of connection of the USB device 21 to the PC 3, transmits the first attachment information to the PC 3 to cause the PC 3 to perform the plug-and-play operation relating to the USB device 21 and connect the USB device 21 to the PC 3 in the form of USB connection.

The projector 1 controls the communication between the USB device 21 and the PC 3 by using the Internet Protocol (IP) technology.

Specifically, the projector 1 capsulates transmission information transmitted by the USB device 21 in an IP packet to produce a transmission packet and transmits the produced transmission packet to the PC 3. The projector 1 decapsulates an IP packet received from the PC 3 to produce reception information and outputs the produced reception information to the USB device 21. In the following description, a method for capsulating transmission information in an IP packet to produce a transmission packet and decapsulating an IP packet to produce reception information is also referred to as “UoIP (USB over IP)”. The projector 1 uses UoIP also in the communication between the USB device 22 and the PC 3.

The PC 3, when connected to the projector 1 in the form of P2P connection, transmits image information G to the projector 1 in accordance with the Miracast standard. The projector 1 can control the communication between the USB device 21 and the PC 3 and the communication between the USB device 22 and the PC 3 during the communication of the image information G with the PC 3.

In the example shown in FIG. 1, the projector 1 controls communication of information P, which is exchanged between the USB devices 21, 22 and the PC 3, while receiving the image information G from the PC 3. The information P is an IP packet produced based on UoIP. The image information G may be still image information or motion image information.

The projector 1 sets the state of each of the USB devices 21 and 22 to be a first state in which the USB device is connected to the PC 3, a second state in which the USB device is connected to the projector 1, or a third state in which the USB device is not connected to the PC 3 or the projector 1. The projector 1, for example, sets the connection state of each of the USB devices 21 and 22 in accordance with an input from the user of the projector 1.

FIG. 2 shows an example of the projector 1 and the PC 3.

The projector 1 includes a wireless communication section 11, a projection section 12, an operation detection section 13, a memory section 14, and a processing section 15.

The wireless communication section 11 wirelessly communicates, for example, with the PC 3. The wireless communication section 11 receives, for example, the image information G from the PC 3 after the projector 1 wirelessly connected to the PC 3. Further, the wireless communication section 11 exchanges information between the PC 3 and the USB device 21 and between the PC 3 and the USB device 22 in wireless communication.

The projection section 12 projects and displays an image according to the image information G on a projection surface SC, such as a screen. The projection section 12 is an example of a display section. The projection surface SC is an example of a display surface. The display section does not include a display surface, such as the projection surface SC.

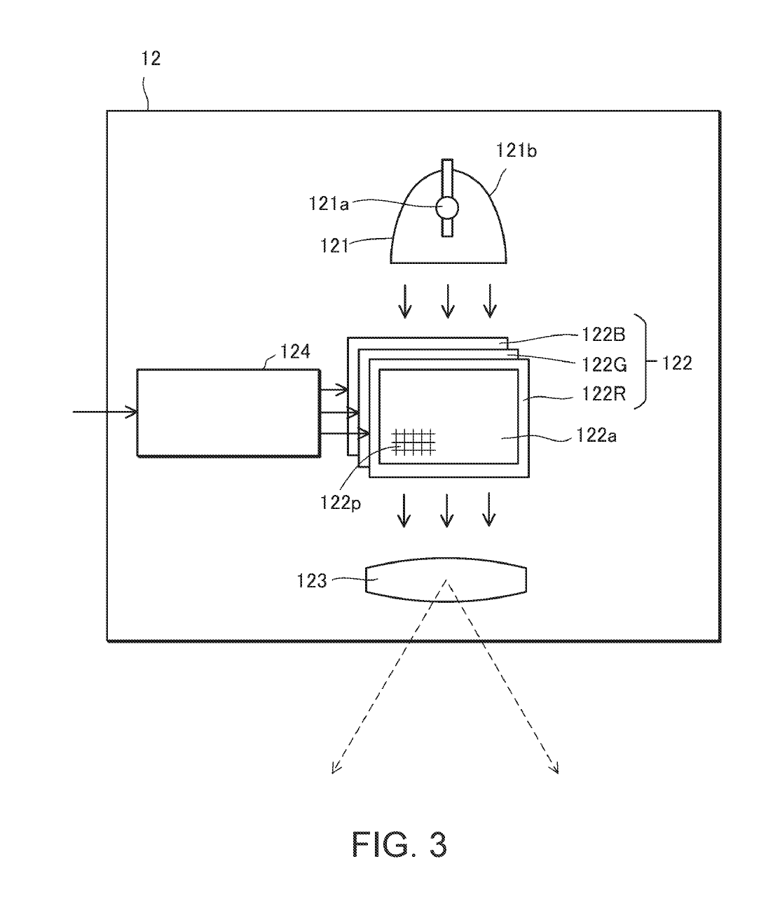

FIG. 3 shows an example of the projection section 12. The projection section 12 includes a light source 121, three liquid crystal light valves 122R, 122G, and 122B, which are each an example of a light modulator, a projection lens 123, which is an example of a projection system, a light valve driver 124, and other components. The liquid crystal light valves 122R, 122G, and 122B are collectively referred to as liquid crystal light valves 122. In the projection section 12, the liquid crystal light valves 122 modulate the light emitted from the light source 121 to form image light, and the projection lens 123 enlarges and projects an image formed by the image light. The image projected by the projection section 12 is also typically referred to as a “projection image” in some cases.

The light source 121 includes a light source section 121a, which is formed, for example, of a xenon lamp, an ultrahigh-pressure mercury lamp, a light emitting diode (LED), or a laser light source, and a reflector 121b, which reduces variation in the direction of the light radiated by the light source section 121a. The light emitted from the light source 121 passes through an optical integration system that is not shown, which reduces variation in the luminance distribution of the light, and the resultant light is then separated by a color separation system that is not shown into red, green, and blue light components, which are the three primary colors of light. In the following description, red referred to as “R”, green referred to as “G”, and blue referred to as “B”. The R, G, and B light components are incident on the liquid crystal light valves 122R, 122G, and 112B, respectively.

The liquid crystal light valves 122 are each formed, for example, of a liquid crystal panel in which a liquid crystal material is encapsulated between a pair of transparent substrates. The liquid crystal light valves 122 each have a rectangular pixel area 122a formed of a plurality of pixels 122p arranged in a matrix. In each of the liquid crystal light valves 122, drive voltage is applicable to the liquid crystal material for each of the pixels 122p. When the light valve driver 124 applies drive voltage according to an image signal inputted from the processing section 15, specifically, an image processing section 153, which will be described later, to each of the pixels 122p, the optical transmittance of the pixel 122p is set at a value according to the image signal. The light emitted from the light source 121 is therefore modulated when passing through each of the pixel areas 122a to form an image according to the image signal on a color basis.

The color images are combined with one another by a light combining system that is not shown on a pixel basis or for each of the pixels 122p into projection image light that is color image light. The projection image light is enlarged and projected by the projection lens 123 onto the projection surface SC.

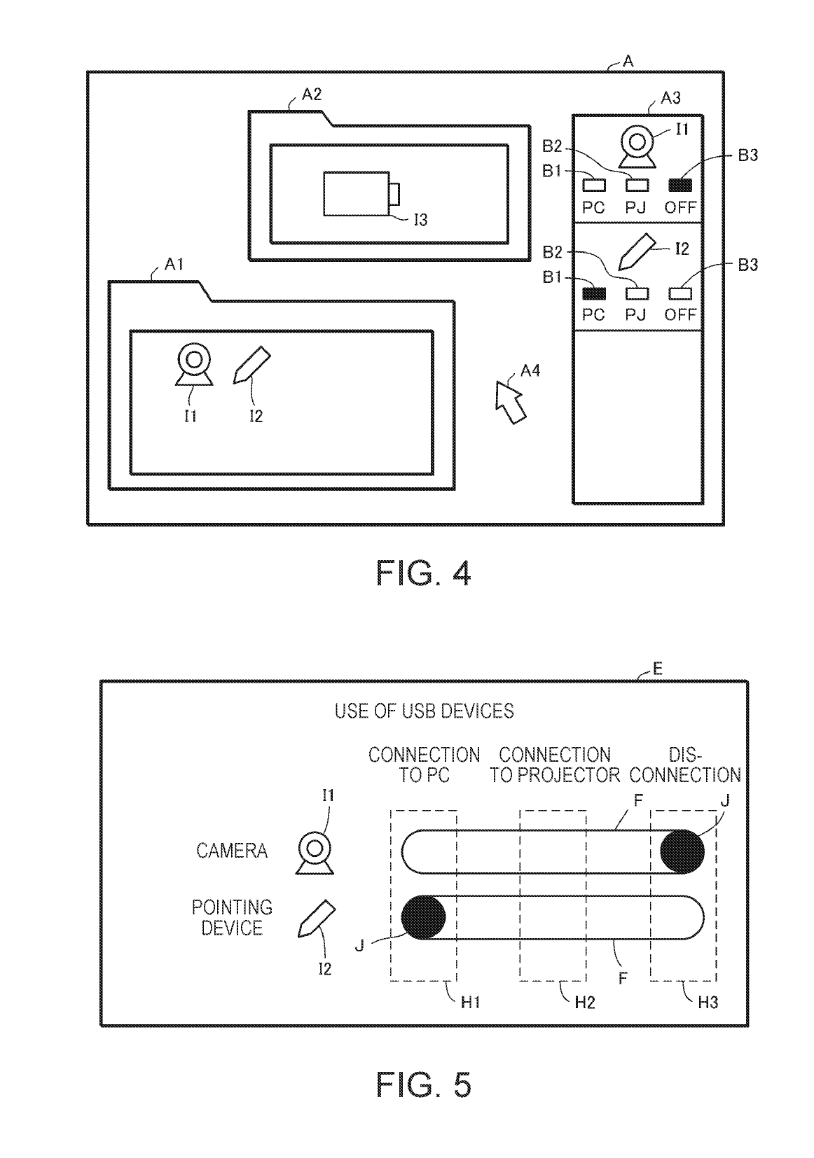

FIG. 4 shows an operation screen A, which is an example of the image projected by the projection section 12.

The operation screen A has a virtual storage folder A1, a device folder A2, a connection setting image A3, and a cursor A4. The portion excluding the connection setting image A3 out of the operation screen A is indicated by the image information G provided from the PC 3. The connection setting image A3 is produced as an on-screen display (OSD) image by the projector 1.

The images of the portions excluding the connection setting image A3 out of the operation screen A, that is, the images representing the virtual storage folder A1, the device folder A2, and the cursor A4 can also be displayed on the PC 3.

The projector 1 produces the operation screen A by superimposing the connection setting image A3 on the image indicated by the image information G.

In the virtual storage folder A1, the USB devices 21 and 22 attached to the projector 1 are drawn in the form of icons. An icon I1 corresponds to the USB device 21, which is a camera device. An icon I2 corresponds to the USB device 22, which is a pointing device.

Information on the USB devices 21 and 22 attached to the projector 1, for example, first device information on the USB device 21 and second device information on the USB device 22, is provided from the projector 1 to the PC 3.

To distinguish the virtual storage folder A1 from a physical storage folder that is not shown, the virtual storage folder A1 is so desirably displayed that the color of the virtual storage folder A1 differs from the color of the physical storage folder.

In the device folder A2, a device present in the network to which the PC 3 belongs is drawn in the form of an icon. A device present in the network to which the PC 3 belongs is hereinafter also referred to as a “network device.” An icon I3 corresponds to the projector 1.

The connection setting image A3 is used to set the state of each of the USB devices 21 and 22 attached to the projector 1 to be the first state, the second state, or the third state. The first state is the state in which the USB device is connected to the PC 3, the second state is the state in which the USB device is connected to the projector 1, and the third state is the state in which the USB device is not connected to the PC 3 or the projector 1, as described above.

The connection setting image A3 shows, for each of the USB devices 21 and 22 attached to the projector 1, the icon of the USB device and three checkboxes B1 to B3. The checkbox B1 is related to the PC 3. The checkbox B2 is related to the projector 1. The checkbox B3 is related to an off state in which the USB device is not connected to the PC 3 or the projector 1.

In the state shown in FIG. 4, out of the checkboxes B1 to B3 corresponding to the USB device 21, the checkbox B3 is checked. The USB device 21 is therefore not connected to the projector 1 or the PC 3 in the form of USB connection. On the other hand, out of the checkboxes B1 to B3 corresponding to the USB device 22, the checkbox B1 is checked. The USB device 22 is therefore connected to the PC 3 in the form of USB connection.

A user can perform the operation input representing the operation of changing a checked one of the checkboxes B1 to B3 to another to set the state of each of the USB devices 21 and 22 attached to the projector 1 to be any of the first, second, and third states.

For example, the user can perform the operation input representing the operation of operating the checkbox B1 corresponding to the icon I1 to set the state of the USB device 21 attached to the projector 1 to be the first state.

The operation input representing the operation of operating the checkbox B1 corresponding to the icon I1 is an example of operation input representing the operation of instructing connection of the first device to an external apparatus.

Referring back to FIG. 2, the operation detection section 13 detects operation input performed on the operation screen A. For example, the operation detection section 13 includes an imaging section that is not shown but captures an image of the projection surface SC to produce a captured image, and the operation detection section 13 detects the operation input performed on the operation screen A based on the captured image produced by the imaging section.

The memory section 14 is a computer readable recording medium. The memory section 14 is, for example, a flash memory. The memory section 14 is not limited to a flash memory and can be changed as appropriate. The memory section 14 memorizes, for example, a program executed by the processing section 15.

The processing section 15 is, for example, a computer, such as a central processing unit (CPU). The processing section 15 may be formed of one or more processors. The processing section 15 reads and executes the program memorized in the memory section 14 to achieve a P2P connection section 151, an image communication execution section 152, an image processing section 153, a USB hub 154, a hub control section 155, a USB communication control section 156, an action control section 157, which functions as a USB host controller, and a web-application server 158. The USB hub 154 and the hub control section 155 are part of a USB hub virtualization section 159.

The P2P connection section 151 uses the wireless communication section 11 to connect the projector 1 to the PC 3 in the form of P2P connection. The image communication execution section 152 communicates the image information G with the PC 3 via the P2P connection section 151 and the wireless communication section 11 in accordance with the Miracast standard. In the following description, in the communication via the P2P connection section 151 and the wireless communication section 11, no description of the P2P connection section 151 and the wireless communication section 11 will be made for ease of the description. The image processing section 153 performs image processing on the image information G received by the image communication execution section 152 to produce an image signal. For example, the image processing section 153 produces the connection setting image A3 as an OSD image and produces an image signal representing the operation screen A, in which the connection setting image A3 is superimposed on the image indicated by the image information G.

The USB hub 154 is an example of an attachment section. The USB devices 21 and 22 can be attached to the USB hub 154.

The hub control section 155 is an example of a setting section. The hub control section 155 has a plug-and-play controlling function and a connection state switching function.

The plug-and-play controlling function will first be described.

The hub control section 155 controls the plug-and-play operation relating to each of the USB devices 21 and 22 attached to the USB hub 154. The hub control section 155 controls the plug-and-play operation relating to each of the USB devices 21 and 22, for example, when the projector 1 is connected to the PC 3 and when the projector 1 accepts a connection instruction, for example, the first connection instruction.

The hub control section 155 does not cause the PC 3 to perform the plug-and-play operation relating to the USB device 21 when the projector 1 is connected to the PC 3. The hub control section 155 causes the PC 3 to perform the plug-and-play operation relating to the USB device 22 when the projector 1 is connected to the PC 3.

For example, the hub control section 155 does not transmit the first attachment information, for example, attachment information representing that the USB device 21 has been attached to the USB hub 154 but transmits the second attachment information, for example, attachment information representing that the USB device 22 has been attached to the USB hub 154 to the PC 3 in accordance with the P2P connection between the PC 3 and the projector 1.

In the present embodiment, the hub control section 155 transmits the second attachment information to the PC 3 via the USB communication control section 156, the P2P connection section 151, and the wireless communication section 11.

In the following description, when the hub control section 155 communicates with the PC 3 via the USB communication control section 156, the P2P connection section 151, and the wireless communication section 11, no description of the fact that the communication is executed via the USB communication control section 156, the P2P connection section 151, and the wireless communication section 11 will be made for ease of the description.

The PC 3, when it receives the second attachment information, functions as a USB host controller and performs the plug-and-play operation relating to the USB device 22 to connect the USB device 22 to the PC 3.

Therefore, when the projector 1 is connected to the PC 3, the processing burden on the PC 3 can be reduced as compared with a case where the PC 3 performs the plug-and-play operation relating to each of the USB devices 21 and 22.

Further, the hub control section 155, when it receives the first connection information, transmits the first connection information to the PC 3 to cause the PC 3 to perform the plug-and-play operation relating to the USB device 21 to connect the USB device 21 to the PC 3. The PC 3 can therefore perform, in accordance with the first connection instruction, the plug-and-play operation relating to the USB device 21 that does not undergo the plug-and-play operation when the projector 1 is connected to the PC 3. The hub control section 155 receives the first connection instruction, for example, from the PC 3.

Further, the hub control section 155 causes the PC 3 to perform the plug-and-play operation relating to the USB device 21 in accordance with operation input performed on the operation screen A and detected by the operation detection section 13 to connect the USB device 21 to the PC 3. For example, when the operation detection section 13 detects operation input representing the operation of operating the checkbox B1 corresponding to the icon I1, the hub control section 155 causes the PC 3 to perform the plug-and-play operation relating to the USB device 21 to connect the USB device 21 to the PC 3. The operation input representing the operation of operating the checkbox B1 corresponding to the icon I1 is an example of first operation input representing the operation of setting the state of the USB device 21 attached to the USB hub 154 to the first state.

The connection state switching function will next be described.

The connection state switching function is the function of setting the connection state of each of the USB devices 21 and 22 attached to the USB hub 154 of the projector 1 to any of the first, second, and third states.

The hub control section 155 sets the connection state of each of the USB devices 21 and 22 to any of the first, second, and third states in accordance, for example, with operation input performed on the connection setting image A3 shown in FIG. 4.

For example, in the case where the operation detection section 13 detects operation input representing the operation of operating the checkbox B1 corresponding to the icon I1, that is, in the case where the connection state of the USB device 21 is set to be the first state, the hub control section 155 operates as follows.

To set the connection state of the USB device 21 to be the first state, the hub control section 155 transmits the first attachment information to the PC 3 as a response to an inquiry concerning the state of the USB hub 154 and inquired by the PC 3, which functions as the USB host controller. The inquiry concerning the state of the USB hub 154 is thereinafter referred to as “state inquiry.” The first attachment information is information representing that the USB device 21 has been attached to the USB hub 154. The PC 3 performs the plug-and-play operation for connecting the USB device 21 to the PC 3 in accordance with the response.

In this situation, the hub control section 155 outputs third attachment information representing that the USB device 21 has not been attached to the USB hub 154 to the action control section 157 in response to a state inquiry from the action control section 157 in the projector 1. The action control section 157 therefore does not perform the plug-and-play operation for connecting the USB device 21 to the projector 1. The third attachment information outputted by the hub control section 155 may be information representing that the USB device 21 has been removed from the USB hub 154.

Further, for example, in a case where the operation detection section 13 detects operation input representing the operation of operating the checkbox B2 corresponding to the icon I1, that is, in a case where the connection state of the USB device 21 is set to be the second state, the hub control section 155 operates as follows.

To set the connection state of the USB device 21 to be the second state, the hub control section 155 transmits the first attachment information to the action control section 157 as a response to the state inquiry from the action control section 157. The action control section 157 performs the plug-and-play operation for connecting the USB device 21 to the projector 1 in accordance with the response.

In this situation, the hub control section 155 outputs the third attachment information representing to the PC 3 in response to the state inquiry from the PC 3. The PC 3 therefore does not perform the plug-and-play operation for connecting the USB device 21 to the PC 3.

Further, for example, in a case where the operation detection section 13 detects operation input representing the operation of operating the checkbox B3 corresponding to the icon I1, that is, in a case where the connection state of the USB device 21 is set to be the third state, the hub control section 155 operates as follows.

To set the connection state of the USB device 21 to be the third state, the hub control section 155 transmits the third attachment information as a response to the state inquiry from each of the action control section 157 and the PC 3. The PC 3 or the action control section 157 therefore does not perform the plug-and-play operation relating to the USB device 21.

The USB communication control section 156 is an example of a control section. The USB communication control section 156 controls the communication between the USB devices 21, 22 and the PC 3 via the USB hub 154 and the hub control section 155. The USB communication control section 156 has the UoIP function.

The UoIP function includes the function of capsulating transmission information outputted by each of the USB devices 21 and 22 in an IP packet to produce a transmission packet and transmitting the transmission packet to the PC 3 and the function of decapsulating an IP packet received from the PC 3 to produce reception information and outputting the reception information to the USB device, as described above.

The USB communication control section 156 receives the transmission information outputted from each of the USB devices 21 and 22 via the USB hub 154 and the hub control section 155 and outputs the reception information to the USB device via the USB hub 154 and the hub control section 155.

The USB communication control section 156 starts controlling, for example, the communication between the USB device 22 and the PC 3 in accordance with the establishment of the connection between the wireless communication section 11 and the PC 3.

The USB communication control section 156 controls the communication using the UoIP function during the period for which the image communication execution section 152 executes the communication of the image information G. For example, the USB communication control section 156 executes packet communication using the UoIP function during the period for which the image communication execution section 152 executes packet communication of the image information G.

The web-application server 158 is accessed, for example, when the icon I3 in the device folder A2 shown in FIG. 4 is operated on the PC 3.

The web-application server 158 provides a source having accessed the web-application server 158a with a web-screen for setting the connection state of each of the USB devices 21 and 22 attached to the USB hub 154 to any of the first, second, and third states.

FIG. 5 shows an example of a web-screen E.

The web-screen E has a guide section F and a button J for each of the icons I1 and I2. The user of the PC 3 uses an operation section 33, which will be described later, to set the position of the button J in each of the guide sections F to a position in any of an area H1 corresponding to the first state, an area H2 corresponding to the second state, and an area H3 corresponding to the third state.

The web-application server 158 outputs a connection instruction of connection of the USB devices 21 and 22 according to the positions of the buttons J on the web-screen E to the hub control section 155. The hub control section 155 sets the connection states of the USB devices 21 and 22 in accordance with the connection instruction.

The USB hub virtualization section 159 is used to connect the USB devices 21 and 22 to the PC 3.

The PC 3 includes a display section 31, a loudspeaker 32, an operation section 33, a wireless communication section 34, a memory section 35, and a processing section 36.

The display section 31 displays a variety of pieces of information. The loudspeaker 32 outputs a variety of types of sound. The operation section 33 is, for example, a keyboard and accepts the user's operation. The wireless communication section 34 wirelessly communicates, for example, with the projector 1.

The memory section 35 is a computer readable recording medium. The memory section 35 is, for example, a hard disk drive. The memory section 35 is not limited to a hard disk drive and can be changed as appropriate. The memory section 35 memorizes, for example, a program executed by the processing section 36 and the image information G.

The processing section 36 is, for example, a computer, such as a CPU. The processing section 36 may be formed of one or more processors. The processing section 36 reads and executes the program memorized in the memory section 35 to achieve a P2P connection section 361, an image communication execution section 362, a USB communication control section 363, and an action control section 364, which functions as a USB host controller.

The P2P connection section 361 uses the wireless communication section 34 to connect the PC 3 to the projector 1 in the form of P2P connection. The image communication execution section 362 communicates the image information G with the projector 1 in accordance with the Miracast standard.

For example, the image communication execution section 362 reads the image information G from the memory section 35 and transmits the image information G to the projector 1 via the P2P connection section 361 and the wireless communication section 34. The image communication execution section 362 may transmit the image information G that is not memorized in the memory section 35, for example, image information produced by the processing section 36 to the projector 1 via the P2P connection section 361 and the wireless communication section 34. In the following description, in the communication via the P2P connection section 361 and the wireless communication section 34, no description of the P2P connection section 361 and the wireless communication section 34 will be made for ease of the description.

The USB communication control section 363 has the function of capsulating USB transmission information outputted by the action control section 364 in an IP packet to produce a transmission packet and transmitting the transmission packet to the projector 1 and the function of decapsulating an IP packet received from the projector 1 to produce reception information and outputting the reception information to the action control section 364. That is, the USB communication control section 363 has the same UoIP function as that of the USB communication control section 156.

The USB communication control section 363 executes packet communication using the UoIP function during the period for which the image communication execution section 362 executes packet communication of the image information G.

The action control section 364 functions as a USB host controller and has a driver for a USB pointing device.

The actions of the projector 1 and the PC 3 will next be described.

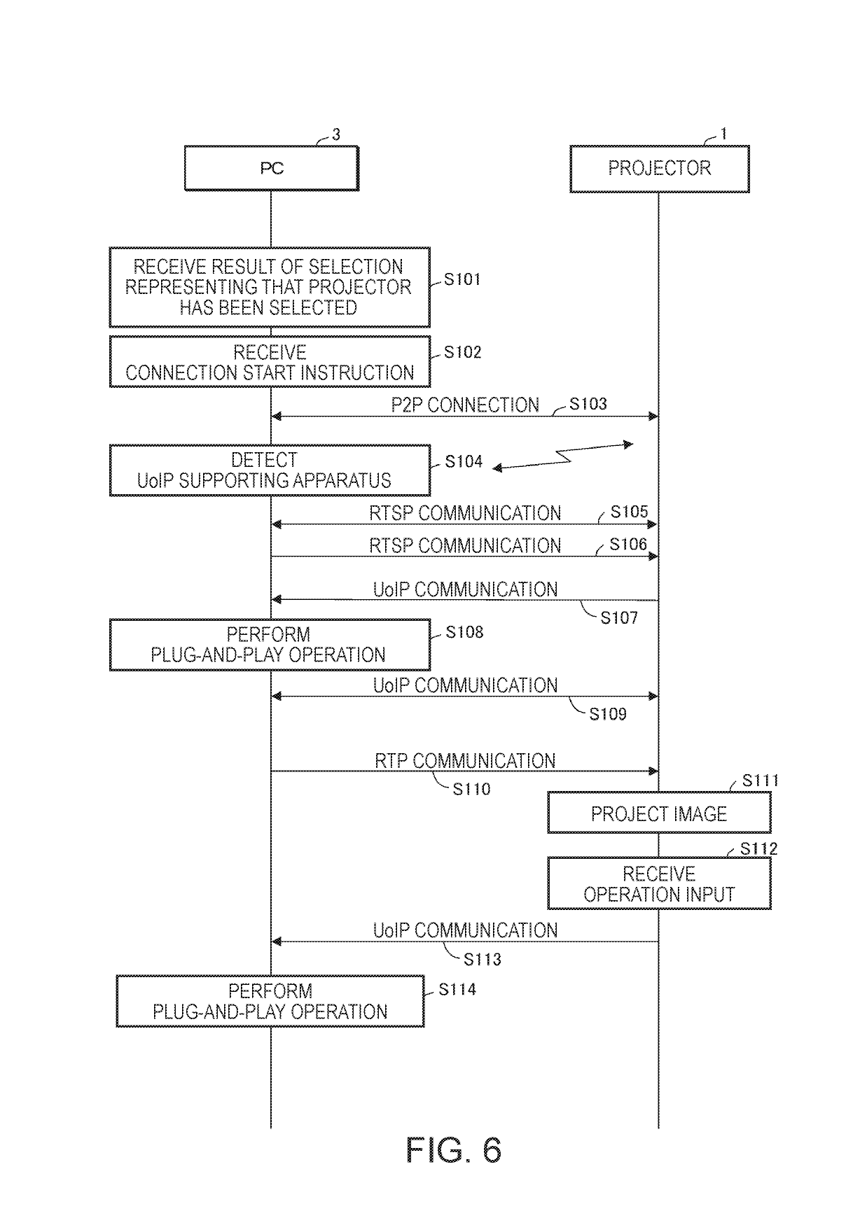

FIG. 6 is a sequence diagram for describing an example of the actions of the projector 1 and the PC 3.

First, in the projector 1, an operation section that is not shown is so operated that the USB hub virtualization section 159 is enabled. Enabling the USB hub virtualization section 159 means, for example, that the function of the hub control section 155 is turned on. In a case where the function of the hub control section 155 is turned on when the projector 1 is powered on, the process of enabling the USB hub virtualization section 159 is omitted.

The PC 3 searches for a reception device that can be connected to the PC 3 in the P2P connection and displays found reception devices on the display section 31. A reception device that can be connected to the PC 3 in the P2P connection is also referred to as a “Miracast reception device.” When the user of the PC 3 operates the operation section 33 to select the projector 1 from Miracast reception devices displayed on the display section 31, the P2P connection section 361 receives in step S10 the result of the selection representing that the projector 1 has been selected.

When the user of the PC 3 subsequently operates the operation section 33 to input a connection start instruction of start of connection to the projector 1 to the PC 3, the P2P connection section 361 receives the connection start instruction and starts authentication for the P2P connection to the projector 1 in step S102. After successful authentication of the projector 1, the P2P connection section 361 is connected to the P2P connection section 151 in the P2P connection in step S103.

The P2P connection section 361 subsequently outputs connection completion notification indicating that the P2P connection has been completed to the image communication execution section 362 and the USB communication control section 363.

Having received the connection completion notification, the USB communication control section 363 starts detection of an apparatus that can perform UoIP in step S104. An apparatus that can perform UoIP is hereinafter also referred to as a “UoIP supporting apparatus.”

In step S104, the USB communication control section 363 detects a UoIP supporting apparatus, for example, by using IP multicast. As an example, the USB communication control section 363 uses IP multicast to transmit UoIP supporting check information representing that a UoIP supporting apparatus needs to respond to the transmitted information and detects a UoIP supporting apparatus based on a response to the transmitted information.

The USB communication control section 363 subsequently evaluates whether or not the projector 1 connected to the PC 3 in the P2P connection is a UoIP supporting apparatus based on the result of the detection of a UoIP supporting apparatus and outputs the result of the evaluation to the image communication execution section 362.

On the other hand, having received the connection completion notification, the image communication execution section 362 executes RTSP communication with the image communication execution section 152 of the projector 1 in step S105 and determines the settings relating to the transmission of the image information G, for example, start of reproduction of the image information G, stop of reproduction of the image information G, the path along which the image information G is transmitted, and the resolution of the image information G.

Having received the result of the evaluation from the USB communication control section 363 showing that the projector 1 is a UoIP supporting apparatus, the image communication execution section 362 transmits UoIP non-supporting information representing that the PC 3 does not support UIBC (user input back channel) to the projector 1 in step S106 to stop UIBC communication.

UIBC is a standard for notifying an apparatus connected to the projector 1 in accordance with the Miracast standard of the coordinates of the pointing device built in the projector 1.

Transmitting the UoIP non-supporting information in step S106 can prevent communication of the same information in the UIBC communication and the UoIP communication. Having received the UoIP non-supporting information, the image communication execution section 152 of the projector 1 does not execute UIBC communication.

In a case where the image communication execution section 362 receives the result of the evaluation showing that the projector 1 is not a UoIP supporting apparatus from the USB communication control section 363, the image communication execution section 362 transmits no UoIP non-supporting information because it is unnecessary to stop the UIBC communication.

On the other hand, having transmitted a response to the UoIP supporting check information, the hub control section 155 of the projector 1 does not transmit the first attachment information to the PC 3 but transmits the second attachment information to the PC 3 via the USB communication control section 156 and the P2P connection section 151 in step S107.

In the present embodiment, the hub control section 155 also transmits virtual storage information on a virtual storage that stores information on the USB device 21 and information on the USB device 21 to the PC 3 via the USB communication control section 156 and the P2P connection section 151 in step S107.

The information on the USB device 21 stored in the virtual storage is, for example, information representing the USB device class of the USB device 21. The information on the USB device 21 is an example of the first device information on the first device.

The information on the USB device 22 stored in the virtual storage is, for example, information representing the USB device class of the USB device 22. The information on the USB device 22 is an example of the second device information on the second device.

The USB communication control section 156 capsulates the second attachment information and the virtual storage information in an IP packet to produce a transmission packet and transmits the produced transmission packet to the PC 3.

Having received the second attachment information via the USB communication control section 363 and other components, the action control section 364 of the PC 3 performs the plug-and-play operation relating to the USB device 22 to connect the USB device 22 to the PC 3 in step S108.

The action control section 364 has a driver for a USB pointing device. The action control section 364 therefore does not need to carry out the process of newly acquiring the driver for the USB device 22 in the plug-and-play operation relating to the USB device 22. When the PC 3 is connected to the projector 1, an increase in the plug-and-play processing burden on the PC 3 can therefore be reduced.

When the USB device 22 is connected to the PC 3, the action control section 364 starts communication with the USB device 22 in step S109. In the communication, the USB communication control section 363 of the PC 3 and the USB communication control section 156 of the projector 1 use UoIP to control the communication between the action control section 364 and the USB device 22.

Further, the action control section 364 uses the virtual storage information to display the virtual storage folder A1 shown in FIG. 4 on the display section 31.

When the plug-and-play operation in step S108 is completed, the image communication execution section 362 starts transmitting the image information G to the projector 1 in step S110. The image communication execution section 152 of the projector 1 outputs the image information G transmitted from the PC 3 to the image processing section 153.

The image processing section 153 performs image processing on the image information G to produce an image signal.

For example, the image processing section 153 produces an image signal representing the image indicated by the image information G on which the connection setting image A3 shown in FIG. 4 is superimposed.

As an example, in a case where the image indicated by the image information G is an image representing the portion other than the connection setting image A3 out of the operation screen A shown in FIG. 4, the image processing section 153 produces an image signal representing the operation screen A shown in FIG. 4.

The projection section 12 projects and displays an image according to the image signal produced by the image processing section 153 on the projection surface SC.

Thereafter, for example, when the user touches the checkbox B1 corresponding to the icon I1 with a hand in the situation in which the connection setting image A3 is displayed on the projection surface SC, the operation detection section 13 receives in step S112 operation input performed on the checkbox B1.

The hub control section 155 transmits in step S113 the first attachment information to the PC 3 via the USB communication control section 156 and the P2P connection section 151 in accordance with the operation input performed on the checkbox B1 and detected by the operation detection section 13. In step S113, the USB communication control section 156 capsulates the first attachment information in an IP packet to produce a transmission packet and transmits the produced transmission packet to the PC 3.

Having received the first attachment information via the USB communication control section 363 and other components, the action control section 364 of the PC 3 performs the plug-and-play operation relating to the USB device 21 to connect the USB device 21 to the PC 3 in step S114.

The electronic apparatus and the method for controlling the electronic apparatus according to the present embodiment do not cause the PC 3 to perform the plug-and-play operation relating to the USB device 21 out of the devices attached to the electronic apparatus when the projector 1 is connected to the PC 3. An increase in the processing burden on the PC 3 can therefore be suppressed when the projector 1 to which the USB devices are attached is connected to the PC 3.

Further, the electronic apparatus and the method for controlling the electronic apparatus according to the present embodiment allow communication between the USB devices attached to the projector 1 and the PC 3 when the PC 3 and the projector 1 execute communication of the image information G.

On the other hand, the Miracast standard defines a UIBC capable of transmitting the coordinates of a cursor moved with a projector-side pointing device to a terminal apparatus.

UIBC, however, only supports a projector-side input device. UIBC therefore does not allow a terminal apparatus, such as a personal computer, to communicate with a device attached to an electronic apparatus, such as a projector, with the terminal apparatus communicating image information with the electronic apparatus.

In contrast, in the present embodiment, when the PC 3 communicate the image information G to the projector 1, a USB device attached to the projector 1 can communicate with the PC 3, whereby the convenience of the projector 1 and the PC 3 is improved.

Further, in an aspect of the electronic apparatus according to the present embodiment, it is desirable that the devices are each a USB device, and that the control section capsulates transmission information transmitted by the USB device attached to the attachment section in an IP packet to produce a transmission packet, transmits the transmission packet to an external apparatus, decapsulates an IP packet received from the external apparatus to produce reception information, and outputs the reception information to the USB device.

According to the aspect described above, the USB communication between the external apparatus and the device can be executed by using an IP packet.

In the aspect of the electronic apparatus according to the present embodiment, it is desirable that the execution section receives image information after the execution section is connected to the external apparatus, and that the control section starts controlling the communication between the device attached to the attachment section and the external apparatus in accordance with the connection between the execution section and the external apparatus.

According to the aspect described above, the control of the communication between the device attached to the attachment section and the external apparatus can be automatically started in accordance with the connection between the execution section and the external apparatus.

The electronic apparatus and the method for controlling the electronic apparatus according to the present embodiment can set the state of the device attached to the USB hub 154 of the projector 1 to be any of the first state, in which the device is connected to the PC 3 connected to the projector 1, the second state, in which the device is connected to the projector 1, and the third state, in which the device is not connected to the PC 3 or the projector 1. Therefore, in the present embodiment, in the case where the PC 3 is connected to the projector 1, the device attached to the projector 1 can be alternatively connected to the projector 1 and the PC 3, whereby the convenience of the projector 1 and the PC 3 is improved.

Therefore, for example, in a case where a USB microphone device is used as the USB device 22, the following use aspect is conceivable.

In the PC 3 is installed a resident application that amplifies voice collected with the USB microphone device and outputs the amplified voice via the loudspeaker 32 of the PC 3. The application operates along with a presentation application. It is assumed that the PC 3 is installed in a position separate from a presenter and close to the rear side of a conference room. It is further assumed that the projector 1 is installed in a position close to the front side of the conference room.

In this situation, it is assumed that a participant of the presentation claims “The voice of the presenter does not reach the rear side of the conference room.”

The presenter operates the checkbox B1 corresponding to the USB microphone device in the connection setting image A3 to connect the USB microphone device to the PC 3. As a result, voice collected with the USB microphone device is likely to reach the rear side of the conference room.

In a case where the magnitude of the sound from the loudspeaker 32 of the PC 3 is small, the presenter operates the checkbox B2 corresponding to the USB microphone device in the connection setting image A3 to connect the USB microphone device to the projector 1 so that a loudspeaker that is not shown but is part of the projector 1 and can output sound having higher magnitude is used. As a result, the voice from the projector 1 reaches the entire conference room.

In a case where the presenter desires to project the screen of the PC 3 for discussion after the presentation is finished, the presenter operates the checkbox B3 corresponding to the USB microphone device in the connection setting image A3 to disconnect the USB microphone device from the projector 1 or the PC 3 and maintains only the image projection.

In the aspect of the electronic apparatus according to the present embodiment, it is desirable that the electronic apparatus includes the display section that displays the operation screen A, which allows the user to set the state of the device attached to the attachment section to any of the first, second, and third states, on the display surface, and that the operation input is operation input performed on the operation screen A.

According to the aspect described above, the user can set the state of the device attached to the attachment section to any of the first, second, and third states by performing operation input on the operation screen A of the electronic apparatus.

In the aspect of the electronic apparatus according to the present embodiment, it is desirable that the operation input is operation input performed on the external apparatus.

According to the aspect described above, the user can set the state of the device attached to the attachment section to any of the first, second, and third states by performing operation input on the external apparatus.

In the aspect of the electronic apparatus according to the present embodiment, it is desirable that the setting section, when it receives the first operation input that instructs setting of the state of the device attached to the attachment section to be the first state, performs the plug-and-play operation relating to the device attached to the attachment section.

According to the aspect described above, the device attached to the attachment section of the electronic apparatus can be readily connected to the external apparatus.

In the aspect of the electronic apparatus according to the present embodiment, it is desirable that the device is a USB device, that the attachment section is a USB hub, and that the setting section, when it receives the first operation input, transmits attachment information representing that the USB device has been attached to the USB hub to the external apparatus to cause the external apparatus to perform the plug-and-play operation.

According to the aspect described above, since the electronic apparatus functions as the USB hub, the external apparatus can perform the plug-and-play operation in the same manner when the USB device is connected to the USB hub.

### Variations

The invention is not limited to the embodiment described above, and a variety of variations, for example, those that will be described below, are conceivable. Further, one or more variations arbitrarily selected from the following aspects of variations can be combined with one another as appropriate.

### Variation 1

The electronic apparatus is not limited to the projector 1 and can be changed as appropriate. The external apparatus is not limited to the PC 3 and can be changed as appropriate. The number of USB devices attached to the projector 1 is not limited to two and only needs to be at least one. The USB devices are each not limited to a pointing device or a camera device and can be changed as appropriate. For example, any of the USB devices may instead be a document camera for projecting an object on a desktop in the form of an enlarged image, a storage device for storing an information file, a microphone device for amplifying the voice of a presenter present around the projector 1, or a keyboard device used to input a password into the projector 1.

### Variation 2

The specific kind is not limited to the HID class and can be changed as appropriate. For example, a mass storage class (MSC) may be used as the specific kind.

As the specific kind, it is desirable to use a USB device class corresponding to a standard driver installed in a PC, specifically, the operating system (OS) of the PC. Using such a USB device class as the specific kind allows the PC 3 to eliminate the need to externally acquire a driver corresponding to the USB device when the plug-and-play operation is performed, whereby an increase in the processing burden can be suppressed when the plug-and-play operation is performed.

### Variation 3

In step S104 of detecting a UoIP supporting apparatus, the USB communication control section 363 may detect a universal plug-and-play (UPnP) apparatus that supports the simple service discovery protocol (SSDP) as the UoIP supporting device. A UPnP apparatus is indicated by an icon in the device folder A shown in FIG. 4, for example, the icon I3 in FIG. 4.

In the case where a UPnP apparatus is used as the UoIP supporting apparatus, a uniform resource locator (URL) that links to the web-application server 158 is desirably used as the URL of an image displayed when the icon I3 is clicked. In this case, when the icon I3 is clicked, the web-screen E shown in FIG. 5 is displayed.

The user of the PC 3 uses the operation section 33 to perform operation input representing the operation of setting the position of the button J in each of the guide sections F to fall within any of the area H1 corresponding to the first state, the area H2 corresponding to the second state, and the area H3 corresponding to the third state. The operation input representing the operation of setting the position of each of the buttons J by using the operation section 33 is an example of operation input performed on the external apparatus.

When the positions of the buttons J are changed in the web-screen E in accordance with operation inputs performed on the PC 3, the web-application server 158 outputs the connection states of the USB devices 21 and 22 identified by the positions of the buttons J in the web-screen E to the hub control section 155 by using connection instructions representing the connection states. The hub control section 155 sets the connection states of the USB devices 21 and 22 in accordance with the connection instructions, in other words, the operation inputs performed on the PC 3. The URL of the image displayed when the icon I3 is clicked is also referred to as a presentation URL.

In the case where a UPnP apparatus is used as the UoIP supporting apparatus, out of the apparatuses that belong to the network to which the projector 1 belongs, an apparatus different from the PC 3 can also display the device folder A2. In the following description, out of the apparatuses that belong to the network to which the projector 1 belongs, an apparatus different from the PC 3 is referred to as a “specific apparatus.”

When the icon I3 is clicked on the specific apparatus, the web-application server 158 presents the web-screen E to the specific apparatus. When the positions of the buttons J in the web-screen E are changed in the specific apparatus, the web-application server 158 outputs the connection states of the USB devices 21 and 22 identified by the positions of the buttons J in the web-screen E to the hub control section 155 by using connection instructions representing the connection states.

That is, the web-application server 158 can be accessed not only from the PC 3 connected to the projector 1 but another apparatus that belongs to the network to which the projector 1 belongs.

The icon I3 therefore functions as a link to an entrance that remotely changes the destination to which a USB device attached to the projector 1 is connected. Therefore, for example, a facilitator who assists the presenter can click the icon I3 on a PC different from the PC 3 to change the destination to which a USB device attached to the projector 1 is connected.

### Variation 4

The connection state of the USB device 21 may circulate in the following order whenever the icon I1 shown in the virtual storage folder A1 shown in FIG. 4 is clicked: the first state; the second state; the third state; the first state; and so on. Similarly, the connection state of the USB device 22 may circulate in the following order whenever the icon I2 shown in the virtual storage folder A1 is clicked: the first state; the second state; the third state; the first state; and so on.

In this case, for example, the icons I1 and I2 in the virtual storage folder A1 are each a link file, and the processing section 15 of the projector 1, for example, the web-application server 158 is provided with a web application programming interface (WebAPI) linked to the link files.

For example, when the icon I2 in the virtual storage folder A1 is clicked, hypertext transfer protocol (HTTP) access is issued from the PC 3 to the projector 1. The WebAPI outputs a connection instruction to the hub control section 155 in such a way that the connection state of the USB device 22 circulates in the following order: the first state; the second state; the third state; the first state; and so on whenever the access occurs. The hub control section 155 sets the connection states of the USB devices 21 and 22 in accordance with the connection instruction.

The entry of the WebAPI is so set as to allow REST-like WebAPI control for each function of the USB devices.

For example, in a case where the USB device 21 is attached to the USB port number “1” of the USB hub 154 and has a vender ID=1234, a product ID=5678, and a function “1”, the link of the icon I1 of the USB device 21 is assumed to be the following shortcut, provided that the IP address of the projector 1 is 192.168.1.1.

Shortcut having IP address 192.168.1.1 to which the USB port number “1”, the vender ID=1234, the product ID=5678, and the function “1” are added

The hub control section 155 desirably dynamically produces and deletes the link of an icon in the virtual storage folder A1 in accordance with insertion and detachment of a USB device to and from the projector 1.

Notification of a successful or failure change of the connection state of a USB device using WebAPI may contain not only a status code return as WebAPI but a content containing JavaScript that displays the situation of the change in a popup form. JavaScript is a registered trademark.

As a method for causing the entry of the WebAPI to correspond to a USB device attached to the USB hub 154, a list number added to the USB device in accordance with the order at which the projector 1 finds the USB device may be used in place of the physical port number of the USB hub 154 to which the USB device is attached. The relationship between the list number and the USB device is, however, likely to change whenever the projector 1 is activated. Therefore, as the entry of the WebAPI, it is desirable to issue a URL unique to the USB device based on the physical USB port, as described above.

It is further desirable to use an icon representing the USB device class as the icon of a link file. The icon representing the USB device class desirably supports any of the device classes specified in http://www.usb.org/developers/defined_class irrespective of whether or not the projector 1 and the PC 3 support the USB device.

### Variation 5

In a case where the USB device 21 that is a microphone device is connected to the PC 3 via the projector 1, information on the sound collected with the microphone device is sent back to the projector 1, after sent to the PC 3, based on a voice output function according to the Miracast standard. In this case, the sound outputted from the projector 1 is outputted with a delay from the original sound, possibly resulting in sound difficult for the user to hear.

In view of the fact described above, the action control section 157 may turn off the voice output function compliant with the Miracast standard when the microphone device is in operation.

### Variation 6

In a case where a USB device that belongs to an unknown USB device class is connected to the projector 1, the hub control section 155 may select an arbitrary icon from a group of icons of a USB device class preset in advance and assign the assigned icon to the connected USB device.

In this process, the hub control section 155 causes the memory device 14 to memorize icon information representing the icon assigned to the USB device in relation to the vender ID and the product ID of the USB device. The hub control section 155 may refer to the icon information memorized in the memory section 14 and automatically use the icon selected in the past when the USB device is used next time.

### Variation 7

The method for suppressing the processing burden on the PC 3 when the plug-and-play operation relating to a USB device other than the specific kind is performed in accordance with the connection between the projector 1 and the PC 3 is not limited to the method using the first attachment information, the second attachment information, and other pieces of information.

For example, the hub control section 155 may camouflage a USB device other than the specific kind as a USB device of the specific kind, for example, a USB device of the HID class and notify the PC 3 of the camouflaged USB device. In this case, the notification can prevent the PC 3 from acquiring a driver for the USB device other than the specific kind.

Further, the hub control section 155 may stop feeding electricity to a USB device other than the specific kind attached to the USB hub 154 when the projector 1 is connected to the PC 3 to prevent plug-and-play operation relating to the USB device other than the specific kind.

The hub control section 155 may selectively use the methods described above, for example, may use the method for stopping feeding electricity to a USB device other than the specific kind to suppress the power consumption and the method for camouflaging the USB device in the case where the electricity fed to a USB device is not controlled.

### Variation 8

In the embodiment described above, the hub control section 155 sets the state of each of the USB devices 21 and 22 to be any of the first state, in which the USB device is connected to the PC 3, the second state, in which the USB device is connected to the projector 1, and the third state, in which the USB device is not connected to the PC 3 or the projector 1.

However, a USB device that is not supported by the projector 1 does not need to be connected to the projector 1. The hub control section 155 may therefore set a USB device that is not supported by the projector 1 to be the first state or the third state.

To set the connection state of a USB device to be the first state or the third state, for example, the checkbox B2 may be omitted in the connection setting image A3, and the area H2 may be omitted in the web-screen E.

Further, to set the connection state of a USB device to be the first state or the third state, the checkboxes B1 to B3 may be omitted in the connection setting image A3, and the color of the icon may be changed in accordance with the connection state, the first state or the third state. For example, the icon may be displayed as a grey-out icon in the third state, and the icon may have a chromatic color in the first state.

In a case where no USB device is connected to the projector 1, the hub control section 155 may set the state of every USB device to be the first state or the third state.

### Variation 9

In the projection section 12, liquid crystal light valves are used as the light modulator, and the light modulator may not be formed of liquid crystal light valves and can be changed as appropriate. For example, the light modulator may instead be formed of three reflective liquid crystal panels. The light modulator may still instead be formed, for example, of one liquid crystal panel, three digital mirror devices, or one digital mirror device. A digital mirror device is hereinafter referred to as a “DMD.” In the case where only one liquid crystal panel or DMD is used as the light modulator, no members corresponding to the color separation system and the light combining system are required. Further, a configuration including no liquid crystal panel or DMD but capable of modulating light emitted from a light source can be employed as the light modulator.

### Variation 10

The projection section 12 is used as the display section, but the display section is not limited to the projection section 12 and can be changed as appropriate. For example, the display section may be a direct-view display.

### Variation 11

The entirety or part of the plurality of functional sections shown in FIG. 2 may be achieved by hardware that is, for example, an electronic circuit, such as a field programmable gate array (FPGA) and an application specific IC (ASIC).

The entire disclosure of Japanese application Nos. 2017-183296, filed Sep. 25, 2017 and 2017-183297, filed Sep. 25, 2017 are expressly incorporated by reference herein.

What is claimed is:

1. An electronic apparatus comprising:
an execution section that executes communication of image information with an external apparatus;
an attachment section to which a device is attachable; and
a control section that controls communication between the device attached to the attachment section and the external apparatus during a period for which the execution section executes the communication of the image information with the external apparatus.

2. The electronic apparatus according to claim 1,
wherein the device is a USB device, and
the control section capsulates transmission information transmitted by the USB device attached to the attachment section in an IP packet to produce a transmission packet, transmits the transmission packet to the external apparatus, decapsulates an IP packet received from the external apparatus to produce reception information, and outputs the reception information to the USB device.

3. The electronic apparatus according to claim 1,
wherein the execution section receives the image information after the execution section is connected to the external apparatus, and
the control section starts controlling the communication between the device attached to the attachment section and the external apparatus in accordance with the connection between the execution section and the external apparatus.

4. An electronic apparatus comprising:
an attachment section to which a device is attachable; and
a setting section that sets a state of the device attached to the attachment section in accordance with operation input to be any of a first state in which the device is connected to the external apparatus connected to the electronic apparatus, a second state in which the device is connected to the electronic apparatus, and a third state in which the device is not connected to the external apparatus and the electronic apparatus.

5. The electronic apparatus according to claim 4,
further comprising a display section that displays an operation screen on a display surface, the operation screen allowing setting of the state of the device attached to the attachment section to be any of the first, second, and third states, and
the operation input is operation input performed on the operation screen.

6. The electronic apparatus according to claim 4,
wherein the operation input is operation input performed on the external apparatus.

7. The electronic apparatus according to claim 4,
wherein when the setting section receives a first operation input that instructs setting of the state of the device attached to the attachment section to be the first state, the setting section causes the external apparatus to perform plug-and-play operation relating to the device attached to the attachment section.

8. The electronic apparatus according to claim 7,
wherein the device is a USB device,
the attachment section is a USB hub, and
when the setting section receives the first operation input, the setting section transmits attachment information representing that the USB device has been attached to the USB hub to the external apparatus to cause the external apparatus to perform the plug-and-play operation.

9. A method for controlling an electronic apparatus including an attachment section to which a device is attached, the method comprising:
executing communication of image information with an external apparatus; and
controlling communication between the device attached to the attachment section and the external apparatus during a period for which the communication of the image information with the external apparatus is executed.
